(19) United States
(12) Patent Application Publication
(10) Pub. No.: US 2013/0088448 A1
(43) Pub. Date: Apr. 11, 2013

(54) TOUCH SCREEN PANEL

(71) Applicant: Samsung Electronics Co., Ltd., Gyeonggi-do (KR)

(72) Inventors: Ho-Seong Seo, Gyeonggi-do (KR); Shi-Yun Cho, Gyeonggi-do (KR); Young-Min Lee, Gyeonggi-do (KR)

(73) Assignee: Samsung Electronics Co., Ltd., Gyeonggi-do (KR)

(21) Appl. No.: 13/629,099

(22) Filed: Sep. 27, 2012

(30) Foreign Application Priority Data
Sep. 30, 2011 (KR) 10-2011-0100285

(51) Int. Cl. G06F 3/0488

(52) U.S. Cl. CPC G06F 3/0488
USPC 345/173

(57) ABSTRACT

A touch screen panel is provided. The touch screen panel includes a first electrode pattern including a plurality of row patterns, each row pattern including a plurality of closed ring-shaped first electrodes disposed in a row, each of the first electrodes having an opening in a central portion thereof; and a second electrode pattern including a plurality of column patterns, each column pattern including a plurality of second electrodes disposed in a column.

### PRIORITY

This application claims priority under 35 U.S.C. §119(a) to Korean Application Serial No. 10-2011-0100285, which was filed in the Korean Intellectual Property Office on Sep. 30, 2011, the entire content of which is incorporated herein by reference.

### BACKGROUND OF THE INVENTION

1. Field of the Invention

The present invention relates generally to a capacitive touch screen panel, and more particularly, to a touch screen panel structure for improving sensitivity of touch recognition with respect to the touch screen panel.

2. Description of the Related Art

In recent years, many display apparatuses have used a touch screen for inputting electrical graphic signals by touching the screen with a user's hand or an object. Such a touch screen is mainly employed in personal portable terminals such as smart phones, tablets, notebook computers, an all-in-one Personal Computers (PCs), Portable

Multimedia Players (PMPs), portable gaming devices, cameras, banking information terminals such as Automatic Teller Machines (ATMs), etc. In contrast to other input devices such as a keyboard and a mouse, when using a touch screen, information is input at a position indicated by a user on the screen. Thus, touch screens are suitable for graphic work such as Computer-Aided Design (CAD), and are widely used to provide an intuitive and convenient user interface.

Touch screens may be roughly classified into resistive touch screens and capacitive touch screens, according to how they detect a position indicated by a user.

A resistive touch screen detects a position at which a user presses the screen, by sensing a change in current with respect to a Direct Current (DC) voltage applied thereto. In particular, a resistive touch screen detects a direct contact between two thin conductive layers on the screen, which results from pressure applied by a fingertip or a stylus pen. Since a resistive touch screen detects a position by pressure, a resistive touch screen may detect any object touching the screen regardless of whether the object is a conductor or a nonconductor.

A capacitive touch screen detects a touch point using capacitance coupling with an Alternating Current (AC) voltage applied thereto. Capacitive touch screens tend to be widely used in smart phones, tablets, etc., due to advantages of high durability, high response speed, and multi-touch ability.

By contrast, a capacitive touch screen can only detect conductive objects, and requires contact over at least a minimum contact area in order to ensure a detectable change in capacitance. Therefore, a capacitive touch screen can reliably detect a position when an input operation is performed by a user's fingertip, but when a conductive tip is used, a capacitive touch screen may have difficulty in position detection due to a small contact area of the conductive tip. In addition, a capacitive touch screen may have difficulty in performing touch recognition when a contact area is rather too large, depending upon the particular manner in which the touch screen panel is formed.

### SUMMARY OF THE INVENTION

Accordingly, an aspect of the present invention is to address at least the above-described problems, and to provide at least the advantages described below.

Another aspect of the present invention is to provide a touch screen panel for improving the sensitivity of touch recognition and preventing erroneous recognition from being caused by a touch input over a large area.

According to an aspect of the present invention, a touch screen panel is provided. The touch screen panel includes a first electrode pattern including a plurality of row patterns, each row pattern including a plurality of closed ring-shaped first electrodes disposed in a row, each of the first electrodes having an opening in a central portion thereof; and a second electrode pattern including a plurality of column patterns, each column pattern including a plurality of second electrodes disposed in a column.

### BRIEF DESCRIPTION OF THE DRAWINGS

The above and other aspects, features, and advantages of the present invention will be more apparent from the following detailed description taken in conjunction with the accompanying drawings, in which:

FIG. 1 is a diagram graphically illustrating recognition sensitivity in a touch screen as a function of a touch area;

FIG. 2 is a diagram illustrating a configuration of X-axis and Y-axis sensing lines in a conventional touch panel;

FIG. 3A illustrates a structure of a touch screen panel according to an embodiment of the present invention;

FIG. 3B is a diagram illustrating a configuration of Y-axis sensing lines in the touch screen panel of FIG. 3A according to an embodiment of the present invention;

FIG. 3C is a diagram illustrating a configuration of X-axis sensing lines in the touch screen panel of FIG. 3A according to an embodiment of the present invention;

FIGS. 4A and 4B are diagrams schematically illustrating charge transfer in a section of a conventional touch screen panel; and

FIGS. 5A and 5B are diagrams schematically illustrating charge transfer in a section of a touch screen panel according to an embodiment of the present invention.

### DETAILED DESCRIPTION OF EMBODIMENTS OF THE PRESENT INVENTION

Hereinafter, various embodiments of the present invention are described with reference to the accompanying drawings. In the following description, the same or similar elements may be designated by the same reference numerals in different drawings. Further, various specific definitions found in the following description are provided only to help general understanding of the present invention, and embodiments of the present invention can be implemented without being limited to such definitions. Further, in the following description of embodiments of the present invention, detailed descriptions of known functions and configurations incorporated herein may be omitted when such a description may obscure the subject matter of the present invention.

A capacitive touch screen detects the position of a touch input by using capacitance coupling. Accordingly, a capacitive touch screen detects the position of a touch input by sensing a change in current when the touch input occurs.

In a conventional capacitive touch screen panel, the sensitivity of touch recognition is reduced when the window thickness of a display provided with the corresponding touch screen is reduced, and the sensitivity may also vary according to a touch area of a particular touch input.

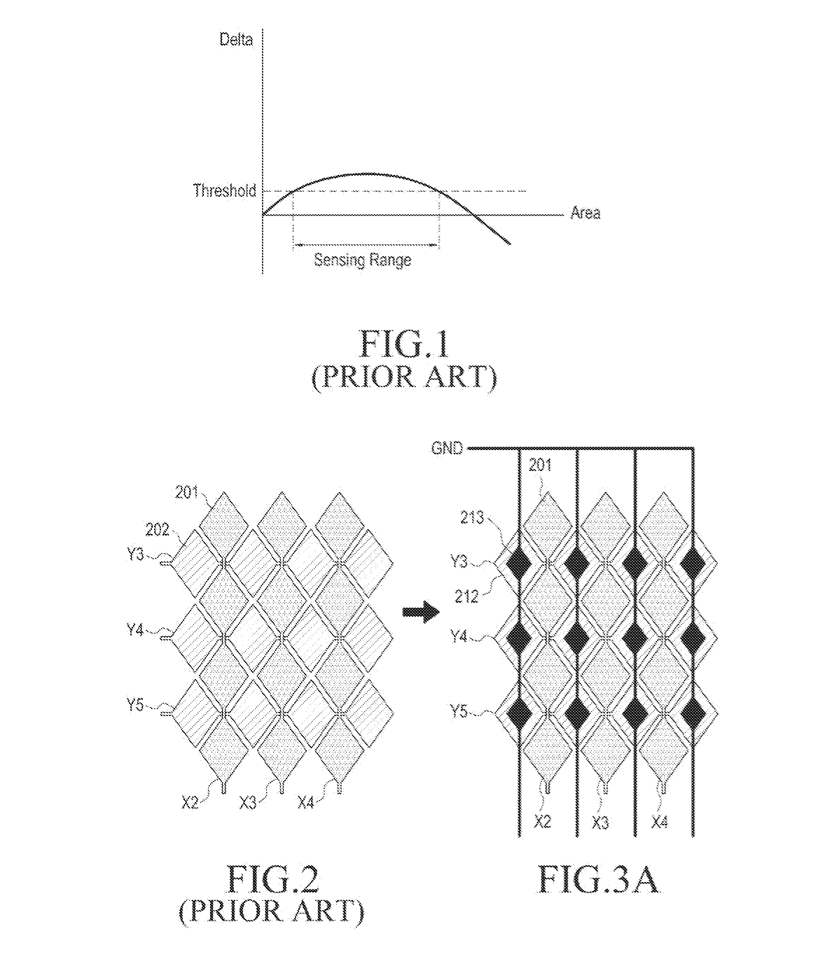

FIG. 1 graphically illustrates recognition sensitivity in a touch screen as a function of touch area.

Referring to FIG. 1, in general, a current change (Delta) according to a touch area gradually increases as the touch area increases, and then reduces again after the touch area increases beyond a certain level, which results in reduced recognition sensitivity.

In order to recognize the position of a touch input, a current change (Delta) according to the touch input must be at least equal to a minimum threshold. Accordingly, in current capacitive touch screens, a touch input cannot be recognized (or can only be recognized with low sensitivity) when the touch input has a very small area or a very large area.

According to embodiments of the present invention, a new pattern touch screen panel is used to improve the recognition sensitivity of a touch screen. Hereinafter, a detailed description of touch screens according to embodiments of the present invention is given with reference to the accompanying drawings.

FIG. 2 illustrates a configuration of X-axis and Y-axis sensing lines in a conventional touch screen panel.

Referring to FIG. 2, the existing touch screen panel includes Y-axis drive electrodes 202 arranged in rows and X-axis sensor electrodes 201 arranged in columns. When a touch input occurs at a specific point on the touch screen, the position of the touch input point is detected by sensing a change in current flowing between the respective electrodes, that is, between Tx and Rx electrodes.

However, a touch input over a large area may result in deterioration in touch recognition performance, because the amount of charges going around and entering the Rx electrode through a fingertip increases.

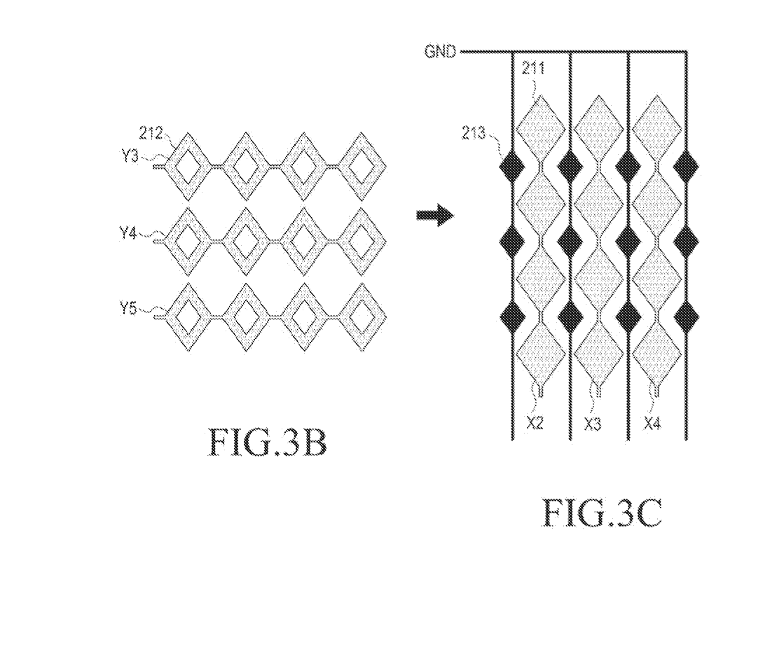

FIG. 3A illustrates a structure of touch screen panel according to an embodiment of the present invention.

Referring to FIG. 3A, in order to minimize the area of the Y-axis drive electrode 202, a touch screen panel according to an embodiment of the present invention includes Y-axis drive electrodes 212, each of which has an area that is reduced by punching the central portion thereof, and a new ground pattern 213 in the corresponding punched portions. X-axis sensing electrodes 211 according to an embodiment of the present invention have the same pattern as that of the existing X-axis sensing electrodes 201.

A configuration of X-axis and Y-axis sensing lines in a touch screen panel according to an embodiment of the present invention is described as follows with reference to FIGS. 3B and 3C.

FIG. 3B illustrates a configuration of an arrangement of Y-axis drive electrodes 212 according to an embodiment of the present invention.

Referring to FIG. 3B, each of the drive electrodes 212 is in the form of a closed ring that has an opening in its central portion. Although FIG. 3B shows an example where each electrode has a rhombic shape, each electrode may have other various shapes in accordance with embodiments of the present invention, such as straight line and rectangular shapes, and the rhombic or rectangular shape of the electrode may have a boundary contour modified to increase boundary surfaces. The rhombic or rectangular shape of the electrode may also be modified by modifying a boundary contour of the rhombic or rectangular shape to increase boundary surfaces. The opening is formed in the central portion of the drive electrode 212 at a certain distance from the boundary surfaces of the drive electrode 212, depending on the shape of the drive electrode 212. This particular manner of forming the opening in the drive electrode 212 reduces an area occupied by a portion remote from the boundary surfaces of the electrode (i.e., the central portion of the electrode), since capacitance between transmission (Tx) and reception (Rx) electrodes mainly occurs at the boundary surfaces of the electrode. These drive electrodes 212 form a drive electrode pattern including a plurality of row patterns, in each of which a plurality of drive electrodes 212 are disposed in a row.

FIG. 3C illustrates a configuration of X-axis sensing electrodes and a ground pattern according to an embodiment of the present invention.

Referring to FIG. 3C, the sensing electrodes 211 according to an embodiment of the present invention form a sensing electrode pattern including a plurality of column patterns, in each of which a plurality of sensing electrodes 211 are disposed in a column, in the same manner as the existing sensing electrodes 201, and each sensing electrode 211 may have the same size as that of the drive electrode 212.

According to an embodiment of the present invention, a ground pattern 213 as shown in FIG. 3C is added in the touch screen panel. The ground pattern 213 includes a plurality of column patterns, in each of which a plurality of ground electrodes are disposed in a row at positions corresponding to the openings formed to reduce the area of each Y-axis drive electrode 212. Each ground electrode may be formed in the same or different form as the opening.

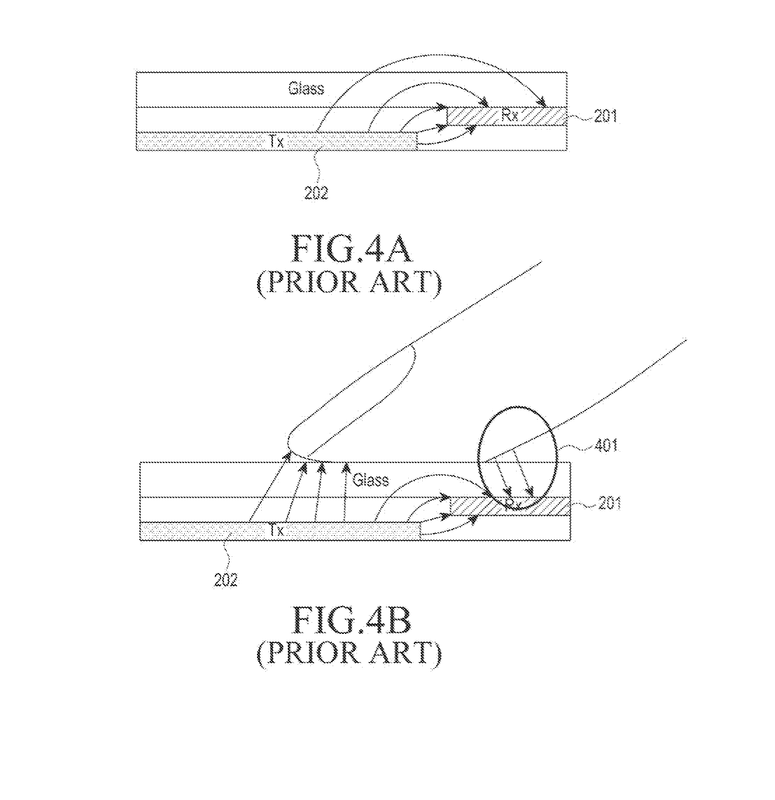

FIGS. 4A and 4B are diagrams schematically illustrating charge transfer in a section of a conventional touch screen panel.

FIG. 4A illustrates charge transfer when there is no touch input in a conventional touch screen panel. In this case, charges are transferred from a Tx electrode 202 corresponding to the Y-axis drive electrode 202 of FIG. 2 to an Rx electrode 201 corresponding to the X-axis sensing electrode 201 of FIG. 2. FIG. 4B shows charge transfer when a touch input over a large area occurs in the conventional touch screen panel. When a fingertip generates a touch input over a large area, charges travel outside of the touch screen panel through the fingertip and enter the Rx electrode 201 through the fingertip, as shown by reference numeral 401, which increases difficulty in recognizing the touch input.

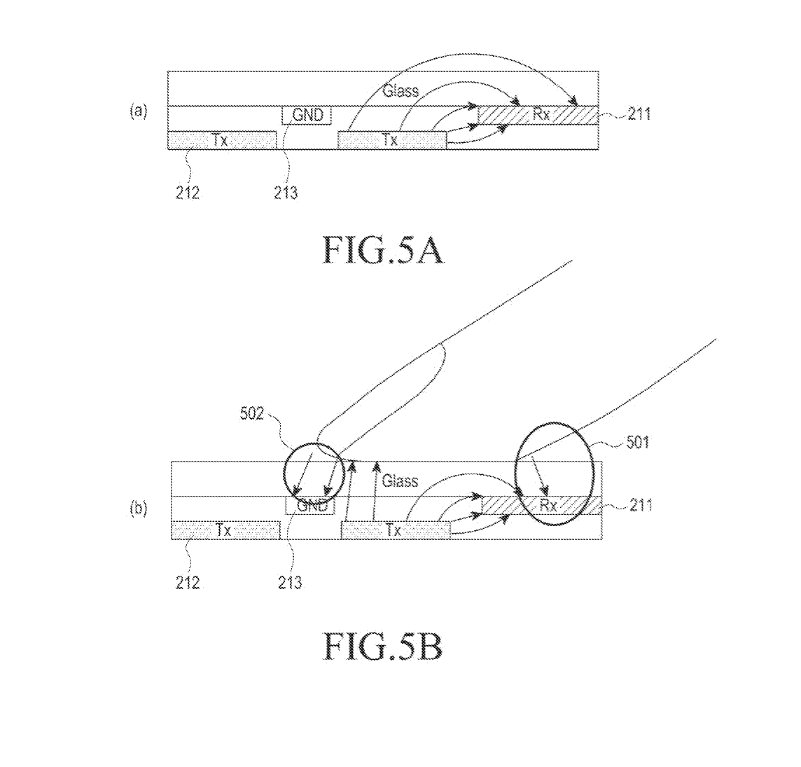

FIGS. 5A and 5B are diagrams schematically illustrating charge transfer in a section of a touch screen panel according to an embodiment of the present invention.

FIG. 5A shows charge transfer when there is no touch input in the touch screen panel according to an embodiment of the present invention.

Referring to FIG. 5A, the inventive touch screen panel includes a closed ring-shaped Tx electrode 212 (corresponding to the Y-axis drive electrode 212 of FIG. 3) having an opening in its central portion, a ground electrode 213 formed at a position corresponding to the opening of the Tx electrode 212, an Rx electrode 211 (corresponding to the X-axis sensing electrode 211 of FIG. 3), and a top plate glass. In the case of no touch input, charges are transferred from the Tx electrode 212 to the Rx electrode 211.

FIG. 5B shows charge transfer in the case where a fingertip generates a touch input over a large area in the touch screen panel according to an embodiment of the present invention. The inventive touch screen panel reduces the amount of charges going round and entering the Rx electrode 211 through the fingertip because the area of the Tx electrode 212 is reduced as compared to the conventional touch screen panel.

Since charges flow out of the fingertip through a capacitor formed between the fingertip and the ground electrode (as designated by reference numeral “502”), the amount of charges that travel through the fingertip and enter the Rx electrode 211, as indicated by reference numeral 501, is further reduced. Therefore, a touch screen panel according to embodiments of the present invention improves the sensitivity of touch recognition as compared to conventional touch screen panels.

As described above, touch screen panels according to embodiments of the present invention improve the sensitivity of touch recognition as compared to the existing touch screen panel and prevent erroneous recognition from being caused by a touch input over a large area. Also, touch screen panels according to embodiments of the present invention address the problem in which recognition sensitivity is lowered according to a decrease in the window thickness of a display window provided in a corresponding touch screen.

While embodiments of the present invention have been shown and described with reference to certain embodiments thereof, it will be understood by those skilled in the art that various changes in form and details may be made therein without departing from the spirit and scope of the present invention as defined by the appended claims.

What is claimed is:

1. A touch screen panel comprising:
a first electrode pattern including a plurality of row patterns, each row pattern including a plurality of closed ring-shaped first electrodes disposed in a row, each of the first electrodes having an opening in a central portion thereof; and
a second electrode pattern including a plurality of column patterns, each column pattern including a plurality of second electrodes disposed in a column.

2. The touch screen panel of claim 1, further comprising a ground pattern including a plurality of ground column patterns, each ground column pattern including a plurality of ground electrodes disposed in a column, the ground electrodes being formed at positions corresponding to each of the openings of the first electrodes.

3. The touch screen panel of claim 1, wherein each of the openings of the first electrodes is formed in the central portion at least a predetermined distance from boundary surfaces of each of the first electrodes, according to a shape of each of the first electrodes.

4. The touch screen panel of claim 2, wherein each of the ground electrodes has the same shape as the openings of the first electrodes.

5. The touch screen panel of claim 1, wherein each of the first electrodes has a rhombic or rectangular shape.

6. The touch screen panel of claim 1, wherein each of the first electrodes has a substantially rhombic or rectangular shape with a boundary contour modified to increase boundary surfaces.

7. The touch screen panel of claim 1, wherein each of the first electrodes has a size and shape corresponding to a size and shape of each of the second electrodes with the exception of the openings of the first electrodes.
